(19) United States
(12) Patent Application Publication
(10) Pub. No.: US 2008/0261080 A1
(43) Pub. Date: Oct. 23, 2008

(54) LONGITUDINAL MAGNETIC RECORDING MEDIUM

(75) Inventors: Hirohisa OHYAMA, Tokyo (JP); Tuqiang Li, Tokyo (JP); Daiji Hasegawa, Miyagi (JP); Shin Saito, Miyagi (JP); Migaku Takahashi, Miyagi (JP)

Correspondence Address: YOUNG & THOMPSON, 209 Madison Street, Suite 500, ALEXANDRIA, VA, 22314, US

(73) Assignees: FUJI ELECTRIC DEVICE TECHNOLOGY CO., LTD., Tokyo (JP); TOHOKU UNIVERSITY, Miyagi (JP)

(21) Appl. No.: 11/962,675

(22) Filed: Dec. 21, 2007

(30) Foreign Application Priority Data
Dec. 22, 2006 (JP) 2006-345966

(51) Int. Cl. G11B 5/66

(52) U.S. Cl. 428/829

(57) ABSTRACT

A magnetic recording medium includes as formed on a non-magnetic substrate, a seed layer, an underlayer of a bcc structure-having Cr alloy, an interlayer of an hcp structure-having Ru alloy, a lower recording layer of a Co—Cr—Pt—B base alloy, an upper recording layer having the same alloying base components as those of the lower recording layer, a larger B atom concentration and having a larger Co atom concentration to Cr atom concentration ratio, and a protective layer. The lower recording layer includes a first and a second lower recording layer. When the B atom concentration in the first lower recording layer is B1 and that of the second lower recording layer is B2, then B1<B2, and when the Co atom concentration to Cr atom concentration ratio in the first lower recording layer is (Co/Cr)1, and that of the second lower recording layer is (Co/Cr)2, then (Co/Cr)1<(Co/Cr)2.

### BACKGROUND OF THE INVENTION

1. Field of the Invention

The present invention relates to a longitudinal magnetic recording medium usable for hard discs.

2. Description of the Background Art

With the recent tendency toward advanced high-density recording in memory devices for information appliances, magnetic heads for reading and writing information data and magnetic recording media in which information data are read and written are being advanced in magnetic recording devices, and therefore, the high-density recording technology is being promoted in magnetic recording media.

For increasing the recording density in magnetic recording media, the coercive force (Hc) of the magnetic recording layer formed of a ferromagnetic metal must be increased, and the S/N ratio (SNR), that is a ratio of reproduced signal to medium noise in recording and reproduction of information signals must be increased.

As well known, at present, in a longitudinal recording medium with a recording layer of a Co alloy, employed is a layered structure as shown in FIG. 2. In FIG. 2, reference number 1 represents a substrate, 2 a seed layer, 3 an underlayer, 4 a stabilization layer, 5 a spacer layer, 6a a lower recording layer, 6b an upper recording layer, and 10 a protective film.

The magnetic recording medium shown in FIG. 2 comprises, as formed on an aluminum substrate or glass substrate 1, a seed layer 2, for example, a seed layer of Ni—P or the like for in-plane orientation of the hcp-c axis of a Co alloy, and a single-layered to triple or so multi-layered, Cr or Cr alloy underlayer 3 formed thereon. Further, a single-layered or double-layered Co—Cr alloy layer 4 having an hcp structure (referred to as a stabilization layer) is formed on it; and a layer 5 of Ru or an Ru alloy with Cr, B or the like added thereto (referred to as a spacer layer) is formed thereon.

Further, two Co—Cr alloy layers having an hcp structure (referred to as recording layers) are laminated on it, or that is, a lower recording layer 6a and an upper recording layer 6b are prepared, and still further, a protective film 10 is prepared on the upper recording layer 6b. In general, a lubricant layer (not shown) is prepared on the surface of the protective film 10.

The above layered structure is referred to as an AFC structure. AFC is an abbreviation of “anti-ferro-coupling”. The spacer layer 5 is made to have a suitable thickness (generally 1 nm or so), whereby the magnetization of the stabilization layer 4 is aligned in antiparallel to the recording layer. Accordingly, the product of remanent magnetization and film thickness (Mrt) of the stabilization layer 4 may cancel out a part of the Mrt of the recording layer, and the volume of the ferromagnetic layer (combined volume of the stabilization layer and the recording layer) that contributes to the thermal stability of the structure may be thereby ensured with no substantial increase in the Mrt in the structure. To that effect, it is said that the medium of the type could satisfy both good thermal stability and good electromagnetic conversion characteristics (and also high-density recording capability) (see Patent Reference 1).

In fact, however, even though the AFC structure is employed, the medium could hardly satisfy both the electromagnetic conversion characteristics and the thermal stability. This is because the electromagnetic conversion characteristics are degraded by the increase in the Mrt of the stabilization layer. There are known various opinions on its reasons, and though not clear, in many media actually in use, the electromagnetic conversion characteristics are prevented from being degraded by reducing the Mrt of the stabilization layer. Accordingly, the improvement in the thermal stability for the purpose of anti-ferro-coupling introduction is not almost expected in practice.

On the other hand, introducing a stabilization layer and a spacer layer that are planned to have a reduced Mrt makes it possible to greatly improve the electromagnetic conversion characteristics of the medium. When the stabilization layer and the spacer layer are so planned as to have a thickness of from 1 to 3 nm or so in total, then the crystal structure of the laminate films changes from the bcc structure (body-centered cubic structure) of the underlayer to an hcp structure (hexagonal close-packed structure). Accordingly, it may be considered that the crystal growth of the recording layer having the same hcp structure could smoothly progress and the density of the crystal defects inside the recording layer may be thereby reduced, and the electromagnetic conversion characteristics of the medium could be therefore improved. When the density of the crystal defects inside the recording layer has increased, then the atomic diffusion of Cr and B that act to cut off the magnetic interaction between the crystal grains in the layer may be insufficient and therefore the intergranular magnetic interaction to cause a noise may increase. For improving the electromagnetic conversion characteristics, the crystal defects must be removed as much as possible.

In the medium having the above-mentioned layered structure, the structure and the magnetic characteristics of the recording layer are investigated in detail. Though relaxed by the stabilization layer/spacer layer therein in some degree, there still exists a region having many crystal defects in the lower part of the recording layer formed on the spacer layer.

For reducing the influence of those crystal defects, it is effective to use a Co alloy having a low saturation magnetization (Ms≦150 emu/cc) and having a low B concentration (approximately 5 atm. %) for the recording layer. The concentration of B that hardly dissolves in Co as solid solution is reduced to promote the crystal growth of the layer, and the Cr concentration is increased (approximately 25 atm.%) to lower the saturation magnetization (Ms) of the layer, whereby the intergranular magnetic interaction in the layer could be reduced. The unit of the saturation magnetization, emu/cc may be converted into an SI unit thereof, according to 1 emu/cc 0.0012566 Wb/m².

However, the simple use of such a Co alloy having a high Cr concentration or a low B and/or Ta concentration for the medium recording layer still has some problems mentioned below. The magnetic characteristics of the medium and the thickness of the magnetic layer must be on the level suitable for the recording and reading head to be used, and, for example, for attaining a recording density of 100 Gb/in², the magnetic characteristics of the recording layer must be such that the saturation magnetization Ms is approximately 200 emu/cc and the magnetic anisotropy constant Ku is approximately from 1.0 to 2.0×10⁶ erg/cc. The unit of the magnetic anisotropy constant, erg/cc may be converted into an SI unit thereof, according to erg/cc=10⁻¹ J/m³.

For controlling the grain diameter distribution that may be a cause of noise like the intergranular magnetic interaction, addition of approximately from 8 to 15 atm.% of B may be necessary. Accordingly, a magnetic recording medium that satisfies the requirements necessary for it could not be planned by the simple use of the above-mentioned Co alloy having a high Cr concentration (approximately 25 atm.%) or a low B concentration (approximately 5 atm. %).

For the reasons mentioned above, it is known that the recording layer is preferably made to have a double-layered structure. For example, when the upper recording layer is formed of a composition having high Ms and Ku and having a high B concentration, then the necessary medium magnetic characteristics mentioned above could be attained. On the other hand, a material having high Ms may have a high intergranular magnetic interaction level. When the lower recording layer is so planned as to have a suitable saturation magnetization value, then the medium Mrt essential to the upper recording layer could be reduced and the magnetic characteristics and the intergranular magnetic interaction could be thereby well balanced.

Patent Reference 2 discloses a magnetic recording medium provided with a double-layered recording layer (magnetic layer) that differs from the above. Patent Reference 2 discloses a technique that “when the total concentration of cobalt and platinum in the lower magnetic layer is made not larger than the total concentration of cobalt and platinum in the upper magnetic layer, then the thermal stability and the electromagnetic conversion characteristics may be bettered”.

Patent Reference 3 discloses a magnetic recording medium provided with a tripe-layered recording layer (magnetic layer) further having one additional magnetic layer. With reference to its abstract, Patent Reference 3 discloses the following: The subject matter is “to provide an in-plane magnetic recording medium which has a high medium S/N and has no problem with its overwrite characteristics and which is excellent in its bit/error rate and is satisfactorily stable to thermal fluctuation”; and the means for attaining it is “a magnetic recording medium comprising, as formed on a substrate in that order, an underlayer film, a magnetic film and a protective film, wherein the magnetic film is a chromium-containing cobalt-base alloy film and has plural magnetic layers laminated with no non-magnetic layer therebetween, the plural magnetic layers have first, second and third magnetic layers, the first magnetic layer is disposed between the underlayer film and the second magnetic layer, the second magnetic layer is disposed between the first magnetic layer and the third magnetic layer, the third magnetic layer is disposed between the second magnetic layer and the protective film, the chromium concentration in the first magnetic layer is lower than the chromium concentration in the second magnetic layer, the thickness of the first magnetic layer is smaller than the thickness of the second magnetic layer, the magnetic layer on the upper layer side of the first magnetic layer further contains platinum and boron, and the chromium concentration in the third magnetic layer is lower than the chromium concentration in the second magnetic layer”.

Apart from the above-mentioned Patent References, further referred to are the following Patent References 4 to 8 as the references that have some relation to the present invention.

| | |
|---|---|
| Patent Reference 1 | JP-A-2003-22511 |
| Patent Reference 2 | JP-A-2006-85751 |
| Patent Reference 3 | JP-A-2006-179133 |
| Patent Reference 4 | JP-A-2001-291223 |
| Patent Reference 5 | JP-A-2006-79729 |
| Patent Reference 6 | JP-A-2000-113442 |
| Patent Reference 7 | JP-A-11-283230 |
| Patent Reference 8 | JP-A-2006-179133 |

As mentioned above, in the magnetic recording medium having a medium layered structure different from those in Patent Reference 2 and Patent Reference 3, in which the recording layer has a double-layered structure and the upper recording layer is formed of a composition having high Ms and Ku and having a high B concentration, the composition of the lower recording layer is so planned, as mentioned in the above, that the contradictory requirements for the reduction in the intergranular magnetic interaction in the initial layer and the reduction in the Mrt of the upper recording layer could be well balanced to thereby suppress the intergranular magnetic interaction in the recording layer as a whole. Accordingly, the medium of the type requires an extremely difficult composition planning mode. One reason for it is, as so mentioned above, the existence of the initial-stage layer in growth formed owing to the crystal structure change between the recording layers from the underlayer.

### SUMMARY OF THE INVENTION

Accordingly, an object of the present invention is to solve the above-mentioned problems and to provide a longitudinal recording medium having both excellent electromagnetic conversion characteristics and excellent thermal fluctuation resistance (thermal stability).

The above object can be attained by the following: Specifically, the invention provides a magnetic recording medium having, as formed on a non-magnetic substrate thereof, a seed layer, an underlayer of a bcc structure-having Cr alloy, an interlayer of an hcp structure-having Ru alloy, a lower recording layer of a Co—Cr—Pt—B base alloy, an upper recording layer having the same alloying base components as those of the lower recording layer, having a larger B atom concentration than in the lower recording layer and having a larger Co atom concentration to Cr atom concentration ratio than therein, and a protective layer, wherein the lower recording layer comprises two layers of a first lower recording layer formed on the side of the interlayer and a second lower recording layer formed on the side of the upper recording layer, and wherein, when the B atom concentration in the first lower recording layer is B1 and the B atom concentration in the second lower recording layer is B2, then the two satisfy a relation of B1<B2, and when the Co atom concentration to Cr atom concentration ratio in the first lower recording layer is (Co/Cr)1, and the Co atom concentration to Cr atom concentration ratio in the second lower recording layer is (Co/Cr)2, then the two satisfy a relation of (Co/Cr)1<(Co/Cr)2.

### BRIEF DESCRIPTION OF THE DRAWINGS

FIG. 1 is a schematic cross-sectional view of a longitudinal recording medium of Examples of the invention.

FIG. 2 is a schematic cross-sectional view of one example of a conventional longitudinal recording medium.

FIG. 3 is a graph showing the electromagnetic conversion characteristics in Example 1 and Comparative Example 1.

FIG. 4 is a graph showing the electromagnetic conversion characteristics in Example 2 and Comparative Example 2.

FIG. 5 is a graph showing the electromagnetic conversion characteristics in Example 3 and Comparative Example 3.

FIG. 6 is a graph showing the electromagnetic conversion characteristics in Example 4 and Comparative Example 1.

FIG. 7 is a graph showing the electromagnetic conversion characteristics in Example 1, Example 3 and Comparative Example 4.

FIG. 8 is a table showing the composition of each recording layer and the Co/Cr atom concentration ratio in each recording layer in Examples and Comparative Examples.

### DETAILED DESCRIPTION OF THE PREFERRED EMBODIMENTS

Including the invention of first aspect, these are described in detail hereinafter.

The lower recording layer is formed of a Co—Cr—Pt—B-M alloy and comprises two layers having a different composition ratio. Specifically, this forms a first lower recording layer and a second lower recording layer. M includes at least one element selected from Cu, Ru, Ag, Zr and Ta that are elements to control the saturation magnetization Ms of the layer not having any influence on the crystal structure in the layer. Of the lower recording layer, the first lower recording layer to be on the interlayer is formed for the purpose of reducing the crystal defects that may be introduced by the lattice misfit to the underlying layer.

In this layer, the concentration of B that interferes with the crystal growth is preferably at most 6.0 atm.% for controlling the initial layer formation. The increase in the B concentration may reduce the grain diameter distribution of the crystal grains and may be effective for improving the SNR characteristics; however, when the concentration is over 6 atm. %, then the crystallinity of the layer may worsen and therefore it may greatly worsen the O/W characteristics (overwrite characteristics) and the SNR characteristics.

In case where Ag, Zr, Ta or the like, of which the ultimate solubility in a Co—Cr base alloy as solid solution therein is low, is added to the first lower recording layer, then its concentration is preferably within a range of the ultimate solubility thereof in a Co—Cr—Pt alloy as solid solution. In the first lower recording layer, the grain boundary formation may be insufficient and the intergranular magnetic interactivity may increase. In the layer, therefore, the saturation magnetization must be suppressed low in some degree. The saturation magnetization value is investigated in a longitudinal recording medium having a single-layered lower recording layer generally used in the art, and Ms≦150 emu/cc or so; and for the purpose of satisfying the magnetic characteristics, the Co to Cr atom concentration ratio is preferably Co/Cr≦2.1. When the saturation magnetization level is over the range, then the O/W characteristics may worsen and, with that, the SNR may also worsen. In particular, a composition of Co/Cr<2.0 is preferred for improvements in O/W and SNR.

The first lower recording layer may form only a part of the initial-stage layer in growth having a high crystal defect density; and from experimental results, its thickness is preferably approximately from 1.5 to 8.0 nm.

Next, of the lower recording layer, the second lower recording layer to be on the head side is formed for the purpose of ensuring smooth epitaxial growth between the first lower recording layer and the upper recording layer to be formed on the second lower recording layer and for ensuring the necessary Mrt in some degree with suppressing noise increase. The B concentration in this layer is preferably high for preventing the grain diameter distribution therein. However, for attaining good epitaxial growth therein, the B concentration in the layer must be higher than the B concentration in the underlying layer and must be lower than the B concentration in the upper recording layer. For ensuring the necessary Mrt with no increase in noise, the Co atom concentration to Cr atom concentration ratio is preferably approximately from 2.1 to 2.3.

As the upper recording layer, at least one layer of a Co—Cr—Pt—B-M alloy is formed. As M, the layer may contain any of Cu, Ru, Ag, Zr and Ta that are Ms-controlling elements not having any influence on the crystal structure in the layer. The upper recording layer may comprise plural layers formed of alloys of the same type, but for attaining good epitaxial growth of the layers, the B concentration in each layer that constitutes the upper recording layer must be higher than the B concentration in the underlying layer and must be lower than the B concentration in the overlying layer.

As the underlayer, at least one layer of a bcc structure-having Cr alloy layer is laminated. Preferably, the underlayer contains at least one element selected from Mo, W, B, Mn and V, in addition to Cr; and preferably, the underlayer has a multi-layered structure of plural layers which are so laminated that their lattice constant may increase toward the side of the recording layer by varying the proportion of the lattice constant-controlling element of Mo, W, B, Mn, V or the like in each layer, like in conventional longitudinal recording media.

The interlayer contains Ru, or in addition to Ru, it may contain at least one element selected from Cr, B, Co and Pt.

At least one such layer is formed as the interlayer.

The recording layer is composed of a lower recording layer of a Co—Cr—Pt—B base alloy, and an upper recording layer having the same alloying base components as those of the lower recording layer, having a larger B atom concentration than in the lower recording layer and having a larger Co atom concentration to Cr atom concentration ratio than therein.

The lower recording layer comprises two layers of a first lower recording layer and a second lower recording layer and the B atom concentration in the first lower recording layer is less than that in the second lower recording layer. Furthermore the Co atom concentration to Cr atom concentration ratio in the first lower recording layer is less than that in the second lower recording layer. The recording layer contains, in addition to Co, an element such as Cr, B or the like that hardly makes up a hcp structure, in which, in addition, Pt enlarges the lattice length; and therefore, if the recording layer is formed directly on the bcc underlayer, the crystal structure change from bcc to hcp could not smoothly go on and the crystal orientation and the structure would be disordered. Accordingly, an Ru alloy layer that may readily make up an hcp structure is previously formed as the interlayer before formation of the recording layer, thereby facilitating the smooth crystal growth in the recording layer. In Patent Reference 3 mentioned above, a triple-layered magnetic layer is provided like in the present invention; however, in the former, an Ru interlayer is not provided. For the recording layer to be formed directly on the Ru interlayer, suitable is a Co—Cr—Pt—B alloy as in the present invention, from the viewpoint of the lattice constant and the grain diameter distribution.

In case where the lattice constant in the underlayer is smaller than that of an Ru alloy, then a Co—Cr-M alloy (where M includes at least one of Ta, B, Pt, Zr and Ru) layer may be formed between the underlayer and the Ru alloy interlayer, whereby the lattice misfit may be relaxed and the layer may be effective for improving the electromagnetic conversion characteristics of the medium.

The invention provides a longitudinal recording medium having both excellent electromagnetic conversion characteristics and excellent thermal fluctuation resistance (thermal stability), in which the interference of the crystal defects caused by the crystal structure change between the underlayer and the recording layer, to the recording layer may be prevented.

### EXAMPLES

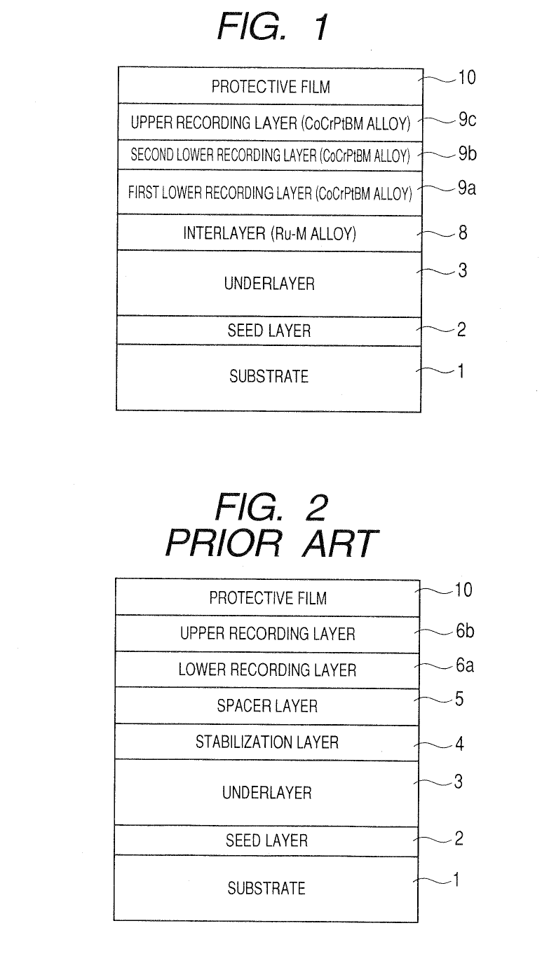

Examples of the invention are described below along with Comparative Examples. FIG. 1 shows a schematic cross-sectional view of the longitudinal recording medium of Examples of the invention. In FIG. 1, reference number 1 represents a substrate, 2 a seed layer, 3 an underlayer, 8 an interlayer, 9a a first lower recording layer, 9b a second lower recording layer, 9c an upper recording layer, and 10 a protective film.

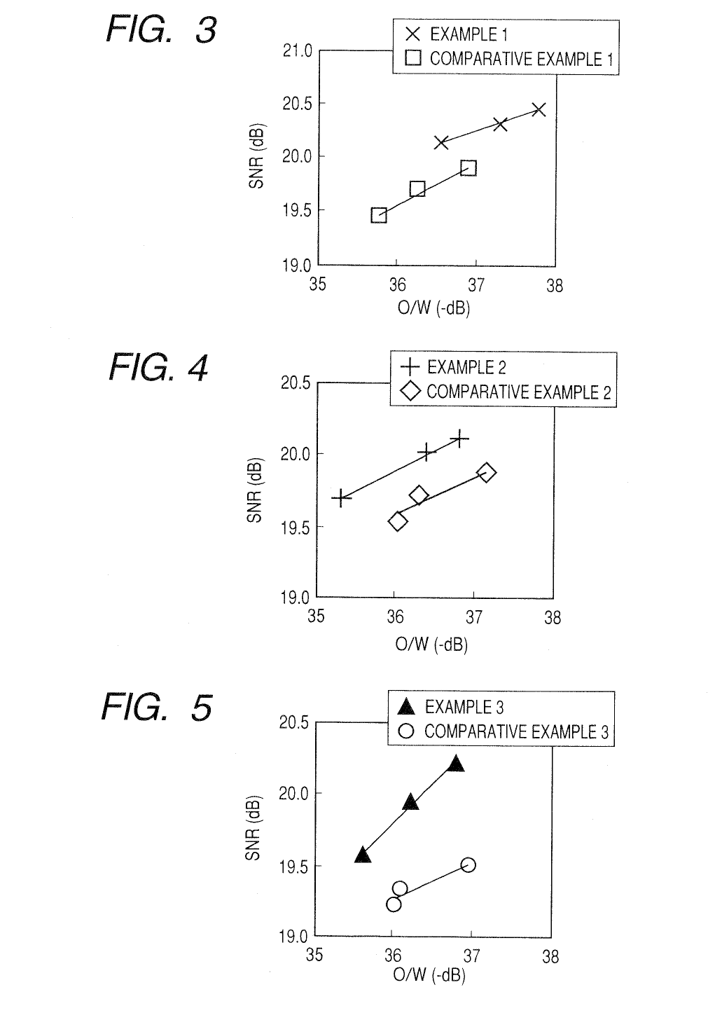

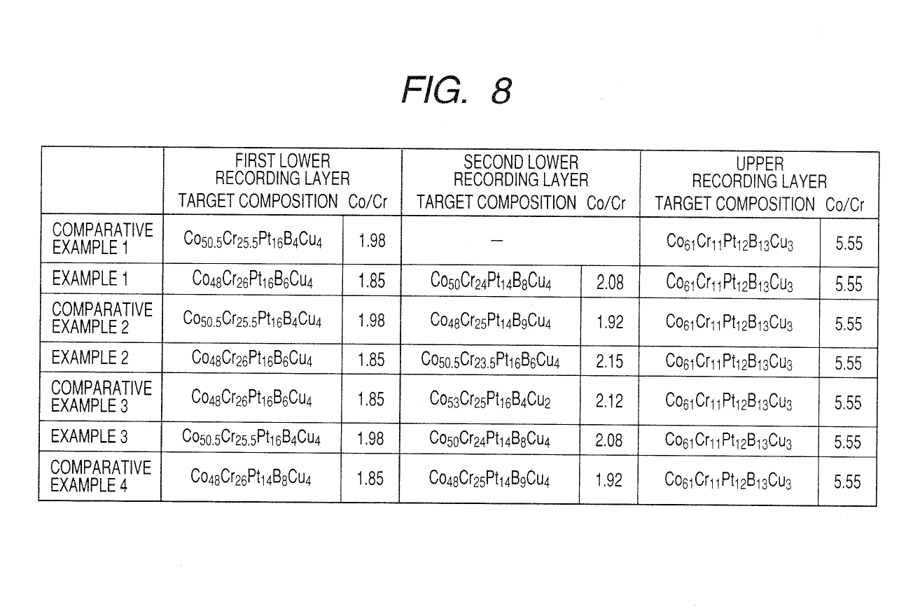

In the following Examples and Comparative Examples, the composition of the first lower recording layer, the second lower recording layer and the upper recording layer, and the ratio of the Co atom concentration to the Cr atom concentration (Co/Cr) in the magnetic recording medium are shown in FIG. 8. The evaluation results of the electromagnetic conversion characteristics of the samples tested are shown in FIG. 3 to FIG. 7 described hereinafter.

The following Examples are merely typical examples to demonstrate some preferred embodiments of the magnetic recording medium of the invention, to which, therefore, the invention should not be limited.

### Example 1

A medium having a layer constitution shown in FIG. 1 was fabricated. As the substrate, used was an Al disc having a diameter of 95 mm, an inner hole diameter of 20 mm and a thickness of 1.27 mm. As the seed layer, 12-μm Ni—P plating was given to the substrate, followed by surface profile processing for Co alloy crystal orientation control in the circumferential/radial direction and for head flying control. Using a lamp heater, the substrate was heated up to 250° C. in a vacuum atmosphere, and then films of Cr (4.0 nm) and Cr₇₀Mo₃₀ (2 nm) were formed in that order as the underlayer, and films of Co₇₆Cr₂₀Ta₄ (2.0 nm) and Ru₈₀Cr₂₀ (0.8 nm) were formed in that order as the interlayer. Further, films of first lower recording layer (7 nm)/second lower recording layer (approximately 8 nm)/upper recording layer (approximately 7 nm)/carbon protective film (3.0 nm) were formed on it in that order, then cooled to room temperature, and a lubricant layer was formed on its surface. The film formation process from the heating step to the carbon protective film forming step was carried out in a cluster type sputtering device equipped with a DC magnetron cathode and CVD.

The conditions for sample fabrication will be described bellow. The target composition used for the recording layer, and the Co/Cr ratio in the lower recording layer are shown in FIG. 8. The B concentration in the first lower recording layer is 6 atm. % and the Co/Cr atom concentration ratio therein is 1.85; the B concentration in the second lower recording layer is 8 atm. % and the Co/Cr atom concentration ratio therein is 2.08; the B concentration in the upper recording layer is 13 atm. % and the Co/Cr atom concentration ratio therein is 5.55. Regarding the magnetic characteristics thereof, the sample was so fabricated that the product of remanent magnetization and film thickness (Mrt) could be 0.39 emu/cm², and the coercive force (Hcr) could fall within a range of from 4.0 kOe to 4.5 kOe.

The above unit of Oe may be converted into an SI unit thereof, according to 1 Oe=79.58 A/m. The substrate condition, the heating condition, and the composition and the thickness of the underlayer to the interlayer were the same for all the samples; and the thickness of the second lower recoding layer and the upper recording layer was so planned that the magnetic characteristics of the fabricated samples could fall within the above-mentioned ranges.

### Comparative Example 1

A sample was fabricated like in Example 1 except that the lower recording layer was a single-layered one, or that is, it was the first lower recording layer alone. The target composition employed is shown in FIG. 8. Regarding the magnetic characteristics thereof, the sample was so fabricated that Mrt could be 0.39 emu/cm², and Hcr could fall within a range of from 4.0 kOe to 4.5 kOe. The substrate condition, the heating condition, and the composition and the thickness of the underlayer to the interlayer were the same for all the samples; and the thickness of the lower recoding layer and the upper recording layer was so planned that the magnetic characteristics of the fabricated samples could fall within the above-mentioned ranges.

### Example 2

A sample was fabricated like in Example 1 except that the composition of the second lower recording layer was varied. The fabrication process and the conditions were the same as in Example 1. The target composition used for the recording layer, and the Co/Cr ratio in the lower recording layer are shown in FIG. 8. In the second lower recording layer, the B concentration is 6 atm. %, and the Co/Cr atom concentration ratio is 2.15.

### Comparative Example 2

As Comparative Example 2, a sample was fabricated like in Example 2 except that the composition of the first lower recording layer and that of the second lower recording layer were varied. The compositions were so planned that the Co/Cr atom concentration ratio in the first lower recording layer (Co/Cr)1 and the Co/Cr atom concentration ratio in the second lower recording layer (Co/Cr)2 could satisfy a relation of (Co/Cr)1>(Co/Cr)2. The sample fabrication process and the conditions were the same as in Example 1. The target composition used for the recording layer, and the Co/Cr ratio in the lower recording layer are shown in FIG. 8. In the first lower recording layer, the B concentration is 4 atm.% and the Co/Cr atom concentration ratio is 1.98; and in the second lower recording layer, the B concentration is 9 atm.% and the Co/Cr atom concentration ratio is 1.92.

### Example 3

A sample was fabricated like in Example 1 except that the composition of the first lower recording layer was varied. The fabrication process and the conditions were the same as in Example 1. The target composition used for the recording layer, and the Co/Cr ratio in the lower recording layer are shown in FIG. 8. In the first lower recording layer, the B concentration is 4 atm.% and the Co/Cr atom concentration ratio is 1.98; and in the second lower recording layer, the B concentration is 8 atm. % and the Co/Cr atom concentration ratio is 2.08.

### Comparative Example 3

As Comparative Example 3, a sample was fabricated like in Example 3 except that the composition of the first lower recording layer and that of the second lower recording layer were varied. The compositions were so planned that the B atom concentration in the first lower recording layer B1 and the B atom concentration in the second lower recording layer B2 could satisfy a relation of B1>B2. The sample fabrication process and the conditions were the same as in Example 1. The target composition used for the recording layer, and the Co/Cr ratio in the lower recording layer are shown in FIG. 8. In the first lower recording layer, the B concentration is 6 atm.% and the Co/Cr atom concentration ratio is 1.85; and in the second lower recording layer, the B concentration is 4 atm. % and the Co/Cr atom concentration ratio is 2.12.

### Example 4

In Example 4, a medium was fabricated like in Example 3 except that its constitution differs from that in Example 3 in that the thickness of the first lower recording layer was varied within a range of from 0 to 9 nm. Regarding the magnetic characteristics thereof, the sample was so fabricated that Mrt could be 0.39 emu/cm², and Hcr could be 4.5 kOe. For the substrate, the heating, and the thickness of the underlayer to the interlayer, the conditions were the same as in Example 3. The thickness of the second lower recording layer and the upper recording layer was so planned that the fabricated samples could have the above-mentioned magnetic characteristics.

### Comparative Example 4

A sample was fabricated like in Example 1 except that the composition of the first lower recording layer and that of the second lower recording layer were varied. The fabrication process and the conditions were the same as in Example 1. The target composition used for the recording layer, and the Co/Cr ratio in the lower recording layer are shown in FIG. 8. In the first lower recording layer, the B concentration is 8 atm.% and the Co/Cr atom concentration ratio is 1.85; and in the second lower recording layer, the B concentration is 9 atm.% and the Co/Cr atom concentration ratio is 1.92.

The samples fabricated in the manner as above were evaluated for their electromagnetic conversion characteristics. The evaluation results are shown in FIG. 3 to FIG. 7. For their evaluation, the samples were tested with a spin-stand type tester, using a composite head having an electromagnetic induction head for recording and a GMR head for reading. The recording frequency is HF of approximately 100 Gn/in²; and the signal/noise ratio, SNR was obtained from the reproduced output in isolation pulse and the medium noise in HF recording.

The electromagnetic conversion characteristics in Example 1 and Comparative Example 1 are shown in FIG. 3. In FIG. 3, the vertical axis indicates SNR (db), and the horizontal axis indicates O/W (−db). Having the double-layered lower recording layer, the samples could have improved SNR characteristics relative to the O/W characteristics thereof.

The electromagnetic conversion characteristics in Example 2 and Comparative Example 2 are shown in FIG. 4. So planned that the Co/Cr atom concentration ratio in the first lower recording layer and in the second lower recording layer, (Co/Cr)1 and (Co/Cr)2 could satisfy (Co/Cr)1<(Co/Cr)2, the samples could have improved SNR characteristics relative to O/W thereof.

The electromagnetic conversion characteristics in Example 3 and Comparative Example 3 are shown in FIG. 5. So planned that the B atom concentration in the first lower recording layer and in the second lower recording layer, B1 and B2 could satisfy B1<B2, the samples could have improved SNR characteristics relative to O/W thereof. This may be because the epitaxial growth in the second lower recording layer from the first lower recording layer could be promoted.

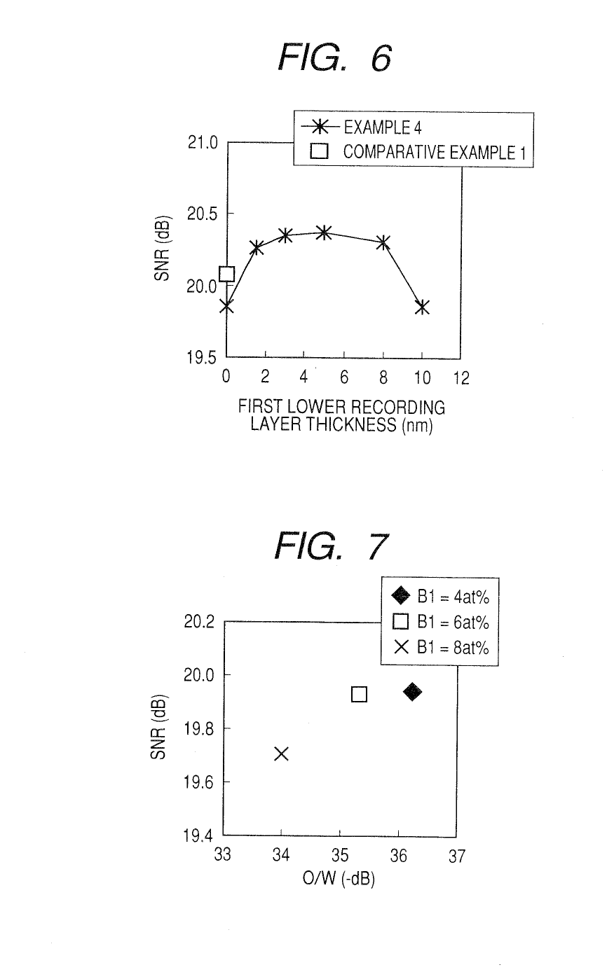

The electromagnetic conversion characteristics in Example 4 and Comparative Example 1 are shown in FIG. 6. Having a double-layered lower recording layer in which the first lower recording layer could have a thickness falling within a range of from 1.5 nm to 8 nm, the samples could have improved SNR characteristics.

The electromagnetic conversion characteristics in Example 1, Example 3 and Comparative Example 4 are shown in FIG. 7. When the B concentration in the first lower recording layer in the samples is over 6 atm.%, then SNR worsens.

As is obvious from the above-mentioned Examples, the invention may prevent the interference of the crystal defects caused by the crystal structure change between the underlayer and the recording layer, to the recording layer, and the medium characteristics may be thereby improved.

What is claimed is:

1. A longitudinal recording medium having, as formed on a non-magnetic substrate thereof, a seed layer, an underlayer of a bcc structure-having Cr alloy, an interlayer of an hcp structure-having Ru alloy, a lower recording layer of a Co—Cr—Pt—B base alloy, an upper recording layer having the same alloying base components as those of the lower recording layer, having a larger B atom concentration than in the lower recording layer and having a larger Co atom concentration to Cr atom concentration ratio than therein, and a protective layer;
wherein the lower recording layer comprises two layers of a first lower recording layer formed on the side of the interlayer and a second lower recording layer formed on the side of the upper recording layer, and wherein, when the B atom concentration in the first lower recording layer is B1 and the B atom concentration in the second lower recording layer is B2, then the two satisfy a relation of B1<B2, and when the Co atom concentration to Cr atom concentration ratio in the first lower recording layer is (Co/Cr)1, and the Co atom concentration to Cr atom concentration ratio in the second lower recording layer is (Co/Cr)2, then the two satisfy a relation of (Co/Cr)1<(Co/Cr)2.

2. The longitudinal recording medium as claimed in claim 1, wherein the thickness of the first lower recording layer is from 1.5 nm to 8 nm.

3. The longitudinal recording medium as claimed in claim 1, wherein the first lower recording layer is such that the B atom concentration therein, B1 is at most 6%, and the Co atom concentration to Cr atom concentration ratio therein, (Co/Cr)1 is at most 2.1.

4. The longitudinal recording medium as claimed in claim 1, wherein each recording layer contains at least one element selected from Cu, Ru, Ag, Zr and Ta, in addition to Co, Cr, Pt and B.

5. The longitudinal recording medium as claimed in claim 1, wherein the underlayer contains at least one element selected from Mo, W, B, Mn and V in addition to Cr.

6. The longitudinal recording medium as claimed in claim 1, wherein the interlayer contains at least one element selected from Cr, B, Co and Pt in addition to Ru.

7. The longitudinal recording medium as claimed in claim 2, wherein the first lower recording layer is such that the B atom concentration therein, B1 is at most 6%, and the Co atom concentration to Cr atom concentration ratio therein, (Co/Cr)1 is at most 2.1.

8. The longitudinal recording medium as claimed in claim 2, wherein each recording layer contains at least one element selected from Cu, Ru, Ag, Zr and Ta, in addition to Co, Cr, Pt and B.

9. The longitudinal recording medium as claimed in claim 3, wherein each recording layer contains at least one element selected from Cu, Ru, Ag, Zr and Ta, in addition to Co, Cr, Pt and B.

10. The longitudinal recording medium as claimed in claim 2, wherein the underlayer contains at least one element selected from Mo, W, B, Mn and V in addition to Cr.

11. The longitudinal recording medium as claimed in claim 3, wherein the underlayer contains at least one element selected from Mo, W, B, Mn and V in addition to Cr.

12. The longitudinal recording medium as claimed in claim 4, wherein the underlayer contains at least one element selected from Mo, W, B, Mn and V in addition to Cr.

13. The longitudinal recording medium as claimed in claim 2, wherein the interlayer contains at least one element selected from Cr, B, Co and Pt in addition to Ru.

14. The longitudinal recording medium as claimed in claim 3, wherein the interlayer contains at least one element selected from Cr, B, Co and Pt in addition to Ru.

15. The longitudinal recording medium as claimed in claim 4, wherein the interlayer contains at least one element selected from Cr, B, Co and Pt in addition to Ru.

16. The longitudinal recording medium as claimed in claim 5, wherein the interlayer contains at least one element selected from Cr, B, Co and Pt in addition to Ru.
